(19) United States
(12) Patent Application Publication
(10) Pub. No.: US 2026/0145639 A1
(43) Pub. Date: May 28, 2026

(54) VEHICLE AND CONTROL METHOD

(71) Applicants: Hyundai Motor Company, Seoul (KR); Kia Corporation, Seoul (KR)

(72) Inventor: Yong Joo LEE, Hwaseong-Si (KR)

(21) Appl. No.: 19/202,713

(22) Filed: May 8, 2025

(30) Foreign Application Priority Data
Nov. 27, 2024 (KR) 10-2024-0171827

(51) Int. Cl. B60R 25/10; B60R 25/30; B60R 25/32

(52) U.S. Cl. CPC B60R 25/1009; B60R 25/305; B60R 25/32

(57) ABSTRACT

A vehicle according to the present disclosure may include an air conditioner configured to control airflow to increase or decrease an interior temperature of the vehicle; a sensor configured to detect, while the vehicle is an alert operation mode, movement inside or outside the vehicle; a processor; and a memory. The memory may store at least one instruction that is configured, when executed by the processor communicating with the memory, to cause the vehicle to: determine, based on a detection signal from the sensor, an intrusion event associated with the vehicle; and generate, based on the intrusion event, an external alarm.

### CROSS-REFERENCE TO RELATED APPLICATION

This application claims priority to and the benefit of Korean Patent Application No. 10-2024-0171827, filed on Nov. 27, 2024, in the Korean Intellectual Property Office, the entire disclosure of which is incorporated herein by reference in its entirety for all purposes.

### BACKGROUND

### 1. Field

The present disclosure relates to a vehicle and a control method, and more specifically relates to vehicle safety.

### 2. Introduction

Some vehicle theft prevention systems may operate to maintain vehicle safety by generating visual or auditory effects (e.g., alarms or alerts) around the vehicle when various hazardous situations occur through detecting breaking of windows for intrusion into a parked vehicle, detecting opening of vehicle doors, detecting theft of items inside the vehicle, detecting theft of tires, detecting illegal towing and movement of the vehicle, and the like.

There are various types of vehicle theft prevention systems that use a pressure, a slope, infrared rays, ultrasonic waves, or the like. In particular, a vehicle intrusion warning system can be installed in a vehicle to warn of intrusion into the vehicle by an unauthorized individual.

Meanwhile, accidental deaths caused by neglect of occupants of a vehicle other than drivers, such as infants, the elderly, and pets, have emerged as a social issue, and the installation of a rear occupant detection system in the vehicle may solve such a problem.

However, the vehicle intrusion warning system and the rear occupant detection system based on ultrasonic waves may trigger false detection when a flow of air associated with operation of an air conditioning unit is detected.

### SUMMARY

The present disclosure is directed to more accurately determining intrusion into a vehicle during an alert mode operation that operates while a vehicle is parked and controlling current consumption to be minimized.

Objects of the present disclosure are not limited to the above-described object, and other objects that are not mentioned will be able to be clearly understood by those skilled in the art from the following description.

According to one or more example embodiments of the present disclosure, a vehicle may include: an air conditioner configured to control airflow to increase or decrease an interior temperature of the vehicle; a sensor configured to detect, while the vehicle is an alert operation mode, movement inside or outside the vehicle; a processor; and a memory. The memory store at least one instruction that is configured, when executed by the processor communicating with the memory, to cause the vehicle to: determine, based on a detection signal from the sensor, an intrusion event associated with the vehicle; and generate, based on the intrusion event, an external alarm.

The sensor may include at least one of: an ultrasonic sensor configured to detect a flow of air inside the vehicle, a cabin camera configured to monitor an interior of the vehicle, a rear occupant alert sensor, a radar configured to monitor an external environment of the vehicle, or a second camera configured to monitor the external environment of the vehicle.

The at least one instruction may be configured, when executed by the processor communicating with the memory, to cause the vehicle to, based on the vehicle being turned off and all doors of the vehicle being locked: send, to the ultrasonic sensor, a signal causing the ultrasonic sensor to start operation; and control the vehicle to enter the alert operation mode.

The at least one instruction may be configured, when executed by the processor communicating with the memory, to cause the vehicle to, based on receiving a remote air conditioning operation signal for the air conditioner while the vehicle is in the alert operation mode: send, to the ultrasonic sensor, a signal causing the ultrasonic sensor to stop operation; and control the vehicle to exit the alert operation mode.

The at least one instruction may be configured, when executed by the processor communicating with the memory, to cause the vehicle to, based on a predetermined time duration elapsing after receiving a remote air conditioning operation end signal for the air conditioner: send, to the ultrasonic sensor, a signal causing the ultrasonic sensor to resume operation; and control the vehicle to resume the alert operation mode.

The at least one instruction may be configured, when executed by the processor communicating with the memory, to cause the vehicle to: send, to the second camera and the radar, a signal causing the second camera and the radar to detect movement outside the vehicle.

The at least one instruction may be configured, when executed by the processor communicating with the memory, to cause the vehicle to: based on receiving one or more detection signals from the second camera or the radar, send, to the cabin camera and the rear occupant alert sensor, a signal causing the cabin camera and the rear occupant alert sensor to start operation; and determine, based on receiving one or more detection signals from the cabin camera or the rear occupant alert sensor, whether the intrusion event occurred.

The at least one instruction may be configured, when executed by the processor communicating with the memory, to cause the vehicle to, based on determining that the intrusion event did not occur: send, to the ultrasonic sensor, a signal causing the ultrasonic sensor to start operation; and control the vehicle to resume the alert operation mode.

According to one or more example embodiments of the present disclosure, a method performed by an apparatus of a vehicle may include: determining whether a condition is satisfied for the vehicle to enter an alert operation mode; while the vehicle is in the alert operation mode, detecting, via an ultrasonic sensor of the vehicle, movement inside the vehicle; determining, based on a detection signal from the ultrasonic sensor, whether an intrusion event associated with the vehicle occurs; while the vehicle is in the alert operation mode, receiving a remote air conditioning operation signal for an air conditioner of the vehicle; based on the air conditioning operation signal: causing the ultrasonic sensor to stop operation, and controlling the vehicle to exit the alert operation mode; and controlling, based on a predetermined time duration elapsing after receiving the remote climate control operation signal, the vehicle to resume detecting, via the ultrasonic sensor, movement inside the vehicle.

Controlling the vehicle to exit the alert operation mode may include: causing, after the ultrasonic sensor stops operation, a camera of the vehicle and a radar of the vehicle to start operation; detecting, based on one or more signals from the camera and the radar, movement outside the vehicle; causing a cabin camera of the vehicle and a rear occupant alert sensor of the vehicle to start operation; and determining, based on one or more signals from the cabin camera and the rear occupant alert sensor, whether an intrusion event associated with the vehicle occurs.

Controlling the vehicle to resume detecting of movement inside the vehicle may be performed after receiving a remote air conditioning operation end signal for the air conditioner.

The condition may include at least one of: the vehicle being turned off, or all doors of the vehicle being locked.

According to one or more example embodiments of the present disclosure, a vehicle may include: a wireless transceiver configured to communicate with a user terminal; an air conditioner configured to control airflow to increase or decrease an interior temperature of the vehicle; a first sensor configured to detect movement inside the vehicle; a second sensor configured to detect movement inside the vehicle; a processor; and a memory. The memory may store at least one instruction that is configured, when executed by the processor communicating with the memory, to cause the vehicle to: activate, based on a first condition being satisfied, the first sensor to detect movement inside the vehicle; based on a second condition being satisfied: deactivate the first sensor, activate the air conditioner to adjust an internal temperature of the vehicle, and activate the second sensor to detect movement inside the vehicle; determine, based on movement detected by the first sensor or movement detected by the second sensor, an intrusion event; and generate, based on the intrusion event, an alarm.

The first sensor may include an ultrasonic sensor configured to detect a flow of air inside the vehicle.

The second sensor may further include at least one of: a cabin camera configured to monitor an interior of the vehicle, a rear occupant alert sensor, a radar configured to monitor an external environment of the vehicle, or a second camera configured to monitor the external environment of the vehicle.

The at least one instruction may be configured, when executed by the processor communicating with the memory, to cause the vehicle to generate the alarm by performing at least one of: causing the vehicle to generate an alarm sound; or
sending, to the user terminal, an alarm signal causing the user terminal to generate an alarm sound.

The at least one instruction may be configured, when executed by the processor communicating with the memory, to cause the vehicle to, based on the internal temperature of the vehicle reaching a target temperature: deactivate the air conditioner; reactivate the first sensor to detect movement inside the vehicle; and deactivate the second sensor.

The at least one instruction may be configured, when executed by the processor communicating with the memory, to cause the vehicle to: receive, from the user terminal via the wireless transceiver, a remote climate control operation signal for adjusting the internal temperature of the vehicle; and determine, based on reception of the remote climate control operation signal, the second condition is satisfied.

The at least one instruction may be configured, when executed by the processor communicating with the memory, to cause the vehicle to determine, based on all doors of the vehicle being locked and no occupant being present in the vehicle, the first condition is satisfied.

### BRIEF DESCRIPTION OF THE DRAWINGS

FIG. 1 is a configuration diagram of a vehicle;

FIG. 2 is a flowchart illustrating a vehicle intrusion detection operation; and

FIG. 3 is a flowchart illustrating a vehicle intrusion detection operation.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Advantages and features of the present disclosure and methods of achieving the advantages and features will be clear with reference to one or more example embodiments described in detail below together with the accompanying drawings. However, the present disclosure is not limited to the example embodiments disclosed herein but will be implemented in various forms. The example embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the example embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of one or more example embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

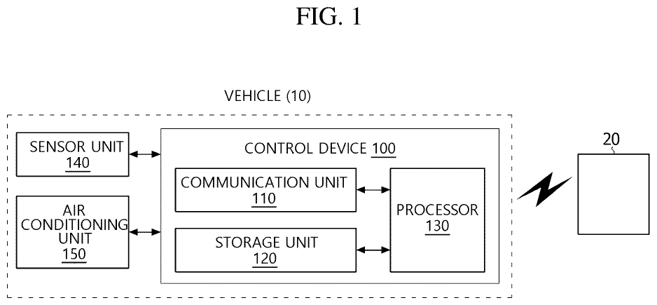

FIG. 1 is a configuration diagram of a vehicle.

Referring to the drawing, a vehicle 10 may include a control device 100, a communication unit 110, a storage unit 120, a processor 130, a sensor unit 140, a climate control system 150.

The control device 100 may be formed integrally with internal components of the vehicle 10. In addition, the control device 100 may be implemented as a separate independent device, and in this case, may be connected to various internal components of the vehicle 10 through wired or wireless communication. For example, the control device 100 may communicate with various modules such as the sensor unit 140 and the climate control system 150 of the vehicle through a vehicle network such as a controller area network (CAN), a local interconnect network (LIN), or Ethernet.

The control device 100 may include a central processing unit and may control various systems including an opening device (e.g., a window or a sunroof) of the vehicle 10 and process real-time data of the vehicle 10 to maintain an optimal vehicle internal environment. One or more controllers (e.g., the control device 100) described herein may include one or more processors, one or more memory and/or one or more storage devices. One or more controllers of the vehicle may disable operation control of one or more components of the vehicle, based on a result of one or more authentication processes and/or verification processes described herein. The vehicle components may include one or more sensors (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control. The vehicle components may also include an auxiliary braking system (e.g., hydraulic retarder, electric retarder), an auxiliary device (e.g., engine brake, exhaust brake, hydraulic retarder, electric retarder, regenerative brake, etc.), a motor, a battery management system, a battery, a communication interface, a controller, a user interface, a key fob, a steering wheel, etc.

The communication unit 110 may communicate with a user terminal 20. The user terminal 20 may include a smartphone, a smart key, or the like. Communication interface(s) (also referred to as communication device(s), communicator(s), communication module(s), communication unit(s), etc.), such as the communication unit 110, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

For example, the communication unit 110 may perform functions of short range communication, global positioning system (GPS) signal reception, vehicle-to-everything (V2X) communication, optical communication, broadcast transmission/reception, and intelligent transport systems (ITS) communication. The communication unit 110 may support short range communication using at least one of Bluetooth, radio frequency identification (RFID), Infrared Data Association (IrDA), ultra-wideband (UWB), ZigBee, near field communication (NFC), Wi-Fi, Wi-Fi Direct, and wireless Universal Serial Bus (USB) techniques. The communication unit 110 may include a mobile communication module using a mobile communication network, and a wireless Internet module for wireless Internet access.

The storage unit 120 may include a memory. The storage unit 120 may be provided inside the processor 130, the control device 100, or the vehicle 10 and may be a separate memory. The storage unit 120 may be configured as a combination of a non-volatile memory, such as a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or a volatile memory, such as a DRAM, a synchronous DRAM (SDRAM), and a double data rate-SDRAM (DDR-SDRAM).

The storage unit 120 may store various data, such as operating software of a vehicle, driver settings, climate control system settings, and vehicle state information, and allow a vehicle control system to access and use the data in real time.

The processor 130 may be electrically or operatively connected to the communication unit 110, the storage unit 120, the sensor unit 140, the climate control system 150, and various internal components of the vehicle 10 and may electrically control the components.

The processor 130 may process signals transmitted between components of the vehicle 10 and perform overall control so that each component may perform its function normally. The processor 130 may be implemented in the form of hardware, implemented in the form of software, or implemented in the form of a combination of hardware and software. The control device 100 may include one or more processors 130.

The control device 100 may include the communication unit 110, the storage unit 120, and the processor 130. The control device 100 may be configured to determine whether intrusion into the vehicle 10 occurs based on a detection signal received from the sensor unit 140 and issue an external alarm.

The sensor unit 140 may be composed of one or more sensors for detecting internal and external situations of the vehicle 10. For example, the sensor unit 140 may include one or more of an ultrasonic sensor, a radar, a built-in camera (e.g., an exterior camera), and a cabin camera (also referred to as an in-cabin camera). In addition, the sensor unit 140 may include a rear occupant alert (ROA) sensor. The radar may detect surroundings of the vehicle, and the built-in camera may monitor the outside of the vehicle. The ultrasonic sensor, the cabin camera, and the ROA sensor may detect the internal situation and movement inside the vehicle. A sensor may include, for example, a camera, a LIDAR, a radar, an infrared sensor, an infrared camera, a thermal imaging camera, a blind spot monitoring sensor, a line departure warning sensor, a parking sensor, a light sensor, a rain sensor, a traction control sensor, an anti-lock braking system sensor, a tire pressure monitoring sensor, a seatbelt sensor, an airbag sensor, a fuel sensor, an emission sensor, a throttle position sensor, a gyroscope, a speedometer, a magnetometer, etc. The sensor may be used, for example, for monitoring surrounding environments and/or autonomous driving control.

The climate control system 150 may control the operation of an air conditioning system (not illustrated) of the vehicle 10.

The climate control system 150 is a component for controlling an internal air condition of the vehicle 10 and serves to manage a temperature, humidity, air quality, and the like of the interior. The climate control system 150 may also be referred to as an air conditioning unit, an air conditioner, an air conditioning system, an HVAC system, a heater, a temperature controller, a climate controller, etc. The climate control system 150 may operate according to the control of the control device 100 and based on internal and external environmental information of the vehicle 10 to control an indoor temperature. The air conditioner, such as the climate control system 150, described herein may include at least one of: a heat pump (e.g., using a refrigerant loop to transfer heat), a resistive heater, a heating, ventilation, and air conditioning (HVAC) system (e.g., including compressors, evaporators, condensers, and/or fans to regulate air of the interior of the vehicle), a cabin air filter (e.g., including a HEPA filter), a refrigerant circuit for circulating refrigerant for cooling and heating, an electric compressor (e.g., powered by a battery of the vehicle), a battery thermal management system, a smart ventilation system (e.g., for auto climate control to adjust fan speed and temperature dynamically), and/or a cabin overheat protection system, etc. The air conditioner, such as the climate control system 150, described herein may be implemented by at least one component for adjusting an interior climate condition of the vehicle (e.g., by controlling airflow in the vehicle).

The climate control system 150 may be composed of various components and functions that control a flow of air inside the vehicle 10 and manage the indoor temperature, humidity, and air quality. The climate control system 150 may include components such as an air inlet, a motor, an evaporator, a heater core, an air filter, a damper, a valve system, a cooling compressor, a temperature and humidity sensor, an air outlet, and the like. Through such a configuration of the climate control system 150, cooling, heating, automatic temperature control, seat-specific air conditioning control, air quality management, humidity control, outside/inside air switching, and/or air flow control functions of the vehicle 10 may be performed.

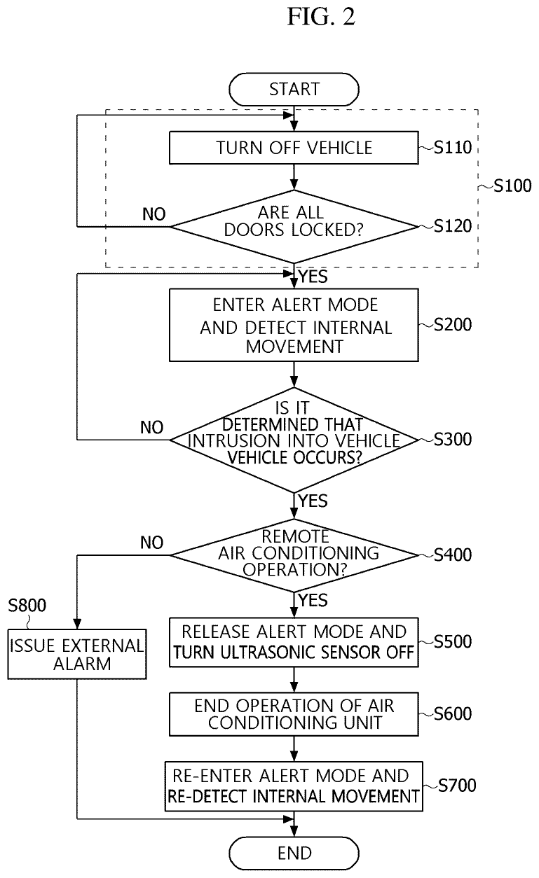

FIG. 2 is a flowchart of a vehicle intrusion detection operation.

The control device 100 confirms whether conditions for the vehicle 10 to enter an alert mode operation (also referred to as an alert operation mode or an alert mode) are satisfied (S100). Here, the conditions for the vehicle 10 to enter the alert mode operation may include cases in which the vehicle 10 is turned off (S110) and all doors are locked (S120).

When it is confirmed that the vehicle 10 is turned off and all doors are locked, the control device 100 outputs an operation start signal (e.g., a signal indicating a start of the alert operation mode) to the sensor unit 140, and controls the vehicle 10 to enter the alert mode operation. In addition, the sensor unit 140 detects movement inside the vehicle 10 through an ultrasonic sensor (S200). The ultrasonic sensor may detect a flow of air inside the vehicle.

Upon receiving a detection signal from the ultrasonic sensor, the control device 100 determines whether intrusion into the vehicle 10 occurs based on the detection signal (S300). Vehicle intrusion determination conditions may be pre-stored in the storage unit 120 of the control device 100 and used.

When intrusion into the vehicle is detected, the control device 100 confirms a remote climate control operation signal for the climate control system 150 provided in the vehicle (S400). That is, when a user of the vehicle 10 other than a driver remotely operates the climate control system 150 through the user terminal 20, a flow of air is generated by the operation of the climate control system 150. Such a flow of air causes false detection of the ultrasonic sensor.

Upon receiving the remote climate control operation signal for the climate control system 150 during the alert mode operation, the control device 100 outputs an operation end signal (e.g., a signal indicating an end of the alert operation mode) to the ultrasonic sensor based on this, and controls the alert mode operation to be stopped (e.g., controls the vehicle to exit the alert operation mode) (S500). The control device 100 may end the vehicle intrusion detection with the operation of the climate control system 150 and the operation of the ultrasonic sensor and transmit information that the alert mode operation has been stopped to the user terminal 20.

When the user remotely ends the operation of the climate control system 150, the control device 100 confirms the remote climate control operation end signal of the climate control system 150 (S600).

Upon receiving the remote climate control operation end signal from the climate control system 150, the control device 100 determines that there is no intrusion into the vehicle. In addition, the control device 100 outputs an operation start signal to the ultrasonic sensor after a preset time (e.g., 10 seconds) elapses (e.g., a predetermined time after receiving the remote climate control operation end signal) and controls the vehicle to re-enter the alert mode operation (S700). Accordingly, the ultrasonic sensor re-performs internal movement detection.

Meanwhile, when the control device 100 does not receive the remote climate control operation signal for the climate control system 150 in operation S400, the control device 100 finally determines that intrusion into the vehicle has occurred and issues an external alarm (S800). The external alarm may include sounding a horn, turning on an emergency light and a headlamp, or the like. In addition, the control device 100 may notify the user terminal 20 of the occurrence of the intrusion into the vehicle by an outsider through the communication unit 110.

In this way, it is possible to minimize current consumption by performing detection using an ultrasonic sensor that is advantageous in reducing current consumption in the alert mode operation while the vehicle is parked.

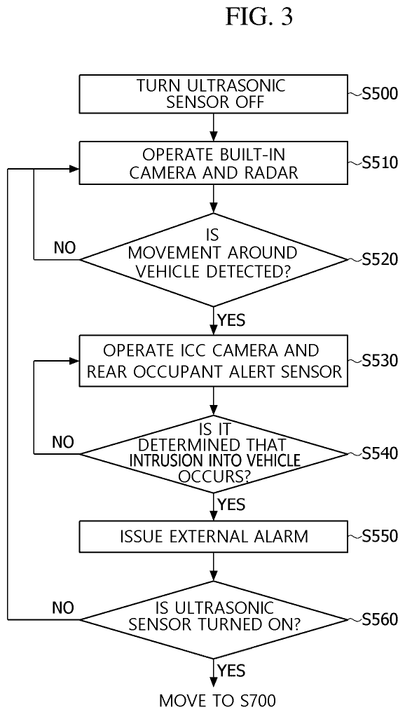

FIG. 3 is a flowchart illustrating a vehicle intrusion detection operation. The vehicle intrusion detection operation as shown in FIG. 3 may be substantially similar to the vehicle intrusion detection operation of FIG. 2. However, there is a difference in that an additional operation is included in the stopping of the alert mode (S500). Hereinafter, the difference will be mainly described.

When the operation of the ultrasonic sensor ends as the operation of the climate control system 150 starts, the control device 100 outputs an operation start signal to the built-in camera and the radar of the sensor unit 140 to operate the built-in camera and the radar (S510).

The control device 100 detects movement around the vehicle based on detection signals received from the built-in camera and the radar (S520). That is, while the climate control system 150 is operating, the operation of the ultrasonic sensor is stopped, and the movement around the vehicle is detected by the built-in camera and the radar.

When the movement around the vehicle is detected, the control device 100 outputs an operation start signal to the cabin camera and the ROA sensor of the sensor unit 140 to operate the cabin camera and the ROA sensor to detect an internal situation of the vehicle (S530).

The control device 100 determines whether intrusion into the vehicle has occurred based on detection signals received from the cabin camera and the ROA sensor (S540).

When it is determined that intrusion into the vehicle has occurred, the control device 100 issues an external alarm (S550). The external alarm may include sounding a horn, turning on an emergency light and a headlamp, or the like. In addition, the control device 100 may notify the user terminal 20 of the occurrence of the intrusion into the vehicle by an outsider through the communication unit 110.

When the external alarm is ended by the user, the control device 100 may confirm the operation of the ultrasonic sensor (S560). In addition, when the operation of the climate control system 150 is ended and the ultrasonic sensor is activated to re-detect the internal movement, the control device 100 controls the vehicle to re-enter the alert mode operation (S700).

In this way, it is possible to minimize current consumption by detecting the movement around the vehicle using the radar and the built-in camera while remote climate control is operated, and as needed, additionally activating the cabin camera and the ROA sensor to detect an internal movement.

According to one or more example embodiments of the present disclosure, it may be possible to minimize current consumption by performing detection using an ultrasonic sensor that is advantageous in reducing the current consumption in an alert mode operation that operates while a vehicle is parked.

In addition, it may be possible to minimize current consumption by detecting movement around a vehicle using a radar and a built-in camera while remote climate control is operated in an alert mode operation, and as needed, additionally activating an cabin camera and/or a rear occupant alert sensor to detect an internal movement.

According to an aspect of the present disclosure, there is provided a vehicle including an air conditioning unit provided in the vehicle, a sensor unit configured to detect internal and external movement of the vehicle when the vehicle enters an alert mode operation, and a control device configured to determine whether intrusion into a vehicle occurs based on a detection signal detected from the sensor unit, wherein the control device is configured to issue an external alarm when it is determined that the intrusion into the vehicle occurs.

The sensor unit may include an ultrasonic sensor configured to detect a flow of air inside the vehicle, an in-cabin camera configured to monitor an inside of the vehicle, a rear occupant alert sensor, a radar configured to detect surroundings of the vehicle, and a built-in camera configured to monitor an outside of the vehicle.

When it is confirmed that the vehicle is turned off and all doors are locked, the control device may output an operation start signal to the ultrasonic sensor and control the vehicle to enter the alert mode operation.

Upon receiving a remote air conditioning operation signal for the air conditioning unit during the alert mode operation, the control device may output an operation end signal to the ultrasonic sensor and control the alert mode operation to be stopped.

Upon receiving a remote air conditioning operation end signal of the air conditioning unit, the control device may output the operation start signal to the ultrasonic sensor after a preset time elapses and control the vehicle to re-enter the alert mode operation.

The control device may be configured to output the operation start signal to the built-in camera and the radar and detect movement around the vehicle based on detection signals received from the built-in camera and the radar.

Upon detecting movement around the vehicle, the control device may be configured to output the operation start signal to the in-cabin camera and the rear occupant alert sensor and determine whether an intrusion into the vehicle occurs based on detection signals received from the in-cabin camera and the rear occupant alert sensor.

When it is determined that there is no intrusion into the vehicle, the control device may output the operation start signal to the ultrasonic sensor and control the vehicle to re-enter the alert mode operation.

According to another aspect of the present disclosure, there is provided a control method including confirming whether a condition for a vehicle to enter an alert mode operation is satisfied through a control device of the vehicle, detecting movement inside the vehicle through an ultrasonic sensor of a sensor unit of the vehicle when the vehicle enters the alert mode operation, determining, by the control device, whether intrusion into the vehicle occurs based on a detection signal of the ultrasonic sensor, confirming, by the control device, a remote air conditioning operation signal for an air conditioning unit provided in the vehicle, ending an operation of the ultrasonic sensor based on the remote air conditioning operation signal and stopping the alert mode operation, and re-entering the alert mode operation after a preset time elapses and re-detecting movement inside the vehicle through the ultrasonic sensor.

The stopping of the alert mode operation may include operating a built-in camera and a radar of the sensor unit after the operation of the ultrasonic sensor has ended, detecting movement around the vehicle based on detection signals of the built-in camera and the radar, operating an in-cabin camera and a rear occupant alert sensor, and determining whether intrusion into the vehicle occurs based on detection signals of the in-cabin camera and the rear occupant alert sensor.

The re-detecting of the movement inside the vehicle may be performed after receiving, by the control device, a remote air conditioning operation end signal of the air conditioning unit.

The condition for the vehicle to enter the alert mode operation may include a case in which the vehicle is turned off and all doors are locked.

Effects of the example embodiments of the present disclosure are not limited to the above-described effects, and other effects that are not mentioned will be able to be clearly understood by those skilled in the art from the following description.

Various example embodiments of the present disclosure do not list all available combinations but are for describing a representative aspect of the present disclosure, and descriptions of various example embodiments may be applied independently or may be applied through a combination of two or more.

One or more example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle comprising:
an air conditioner configured to control airflow to increase or decrease an interior temperature of the vehicle;
a sensor configured to detect, while the vehicle is an alert operation mode, movement inside or outside the vehicle;
a processor; and
a memory storing at least one instruction that is configured, when executed by the processor communicating with the memory, cause the vehicle to:
determine, based on a detection signal from the sensor, an intrusion event associated with the vehicle; and
generate, based on the intrusion event, an external alarm.

2. The vehicle of claim 1, wherein the sensor comprises at least one of:
an ultrasonic sensor configured to detect a flow of air inside the vehicle,
a cabin camera configured to monitor an interior of the vehicle,
a rear occupant alert sensor,
a radar configured to monitor an external environment of the vehicle, or
a second camera configured to monitor the external environment of the vehicle.

3. The vehicle of claim 2, wherein the at least one instruction is configured, when executed by the processor communicating with the memory, to cause the vehicle to, based on the vehicle being turned off and all doors of the vehicle being locked:
send, to the ultrasonic sensor, a signal causing the ultrasonic sensor to start operation; and
control the vehicle to enter the alert operation mode.

4. The vehicle of claim 3, wherein the at least one instruction is configured, when executed by the processor communicating with the memory, to cause the vehicle to, based on receiving a remote air conditioning operation signal for the air conditioner while the vehicle is in the alert operation mode:
send, to the ultrasonic sensor, a signal causing the ultrasonic sensor to stop operation; and
control the vehicle to exit the alert operation mode.

5. The vehicle of claim 4, wherein the at least one instruction is configured, when executed by the processor communicating with the memory, to cause the vehicle to, based on a predetermined time duration elapsing after receiving a remote air conditioning operation end signal for the air conditioner:
send, to the ultrasonic sensor, a signal causing the ultrasonic sensor to resume operation; and
control the vehicle to resume the alert operation mode.

6. The vehicle of claim 4, wherein the at least one instruction is configured, when executed by the processor communicating with the memory, to cause the vehicle to:
send, to the second camera and the radar, a signal causing the second camera and the radar to detect movement outside the vehicle.

7. The vehicle of claim 6, wherein the at least one instruction is configured, when executed by the processor communicating with the memory, to cause the vehicle to:
based on receiving one or more detection signals from the second camera or the radar, send, to the cabin camera and the rear occupant alert sensor, a signal causing the cabin camera and the rear occupant alert sensor to start operation; and
determine, based on receiving one or more detection signals from the cabin camera or the rear occupant alert sensor, whether the intrusion event occurred.

8. The vehicle of claim 7, wherein the at least one instruction is configured, when executed by the processor communicating with the memory, to cause the vehicle to, based on determining that the intrusion event did not occur:
send, to the ultrasonic sensor, a signal causing the ultrasonic sensor to start operation; and
control the vehicle to resume the alert operation mode.

9. A method performed by an apparatus of a vehicle, the method comprising:
determining whether a condition is satisfied for the vehicle to enter an alert operation mode;
while the vehicle is in the alert operation mode, detecting, via an ultrasonic sensor of the vehicle, movement inside the vehicle;
determining, based on a detection signal from the ultrasonic sensor, whether an intrusion event associated with the vehicle occurs;
while the vehicle is in the alert operation mode, receiving a remote air conditioning operation signal for an air conditioner of the vehicle;
based on the air conditioning operation signal:
causing the ultrasonic sensor to stop operation; and
controlling the vehicle to exit the alert operation mode; and
controlling, based on a predetermined time duration elapsing after receiving the remote climate control operation signal, the vehicle to resume detecting, via the ultrasonic sensor, movement inside the vehicle.

10. The method of claim 9, wherein the controlling of the vehicle to exit the alert operation mode comprises:
causing, after the ultrasonic sensor stops operation, a camera of the vehicle and a radar of the vehicle to start operation;
detecting, based on one or more signals from the camera and the radar, movement outside the vehicle;
causing a cabin camera of the vehicle and a rear occupant alert sensor of the vehicle to start operation; and
determining, based on one or more signals from the cabin camera and the rear occupant alert sensor, whether an intrusion event associated with the vehicle occurs.

11. The method of claim 9, wherein the controlling of the vehicle to resume detecting of movement inside the vehicle is performed after receiving a remote air conditioning operation end signal for the air conditioner.

12. The method of claim 9, wherein the condition comprises at least one of:
the vehicle being turned off, or
all doors of the vehicle being locked.

13. A vehicle comprising:
a wireless transceiver configured to communicate with a user terminal;
an air conditioner configured to control airflow to increase or decrease an interior temperature of the vehicle;
a first sensor configured to detect movement inside the vehicle;
a second sensor configured to detect movement inside the vehicle;
a processor; and
a memory storing at least one instruction that is configured, when executed by the processor communicating with the memory, to cause the vehicle to:
activate, based on a first condition being satisfied, the first sensor to detect movement inside the vehicle;
based on a second condition being satisfied:
deactivate the first sensor;
activate the air conditioner to adjust an internal temperature of the vehicle; and
activate the second sensor to detect movement inside the vehicle;
determine, based on movement detected by the first sensor or movement detected by the second sensor, an intrusion event; and
generate, based on the intrusion event, an alarm.

14. The vehicle of claim 13, wherein the first sensor comprises an ultrasonic sensor configured to detect a flow of air inside the vehicle.

15. The vehicle of claim 13, wherein the second sensor further comprises at least one of:
a cabin camera configured to monitor an interior of the vehicle,
a rear occupant alert sensor,
a radar configured to monitor an external environment of the vehicle, or
a second camera configured to monitor the external environment of the vehicle.

16. The vehicle of claim 13, wherein the at least one instruction is configured, when executed by the processor communicating with the memory, to cause the vehicle to generate the alarm by performing at least one of:
causing the vehicle to generate an alarm sound; or
sending, to the user terminal, an alarm signal causing the user terminal to generate an alarm sound.

17. The vehicle of claim 13, wherein the at least one instruction is configured, when executed by the processor communicating with the memory, to cause the vehicle to, based on the internal temperature of the vehicle reaching a target temperature:
deactivate the air conditioner;
reactivate the first sensor to detect movement inside the vehicle; and
deactivate the second sensor.

18. The vehicle of claim 13, wherein the at least one instruction is configured, when executed by the processor communicating with the memory, to cause the vehicle to:
receive, from the user terminal via the wireless transceiver, a remote climate control operation signal for adjusting the internal temperature of the vehicle; and
determine, based on reception of the remote climate control operation signal, the second condition is satisfied.

19. The vehicle of claim 13, wherein the at least one instruction is configured, when executed by the processor communicating with the memory, to cause the vehicle to determine, based on all doors of the vehicle being locked and no occupant being present in the vehicle, the first condition is satisfied.
